(19) United States
(12) Patent Application Publication
(10) Pub. No.: US 2009/0237604 A1
(43) Pub. Date: Sep. 24, 2009

(54) LIQUID CRYSTAL DISPLAY DEVICE AND METHOD FOR MANUFACTURING THE SAME, AND ELECTRONIC APPARATUS

(75) Inventor: Nobukazu NAGAE, Suwa (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/368,507

(22) Filed: Feb. 10, 2009

(30) Foreign Application Priority Data
Mar. 18, 2008 (JP) 2008-069225

(51) Int. Cl. G02F 1/1337

(52) U.S. Cl. 349/124; 349/187; 428/1.23

(57) ABSTRACT

A liquid crystal display device includes: a circuit substrate; a counter substrate oppositely disposed to the circuit substrate; a liquid crystal layer which is sandwiched between the circuit substrate and the counter substrate, and shows a vertical alignment in an initial alignment state; a first alignment layer having an alkyl chain formed by a coating process at a liquid crystal layer of the counter substrate; and a second alignment layer formed by a vacuum process at the liquid crystal layer of the circuit substrate. In the device, an alkyl chain is further bonded on a surface of the second alignment film.

The entire disclosure of Japanese Patent Application No. 2008-069225, filed Mar. 18, 2008 is expressly incorporated by reference herein.

### BACKGROUND

1. Technical Field

The present invention relates to a liquid crystal display device and a method for manufacturing the same, and an electronic apparatus.

2. Related Art

In recent years, a vertical alignment method has been increasingly employed in a liquid crystal display device for a projector as a liquid crystal alignment method. However, in the vertical alignment method, the liquid crystal molecule aligned vertically with respect to a substrate surface, and has poor interaction in an azimuth direction of tilting when a voltage is applied. Therefore, when the voltage is applied, the liquid crystal molecule tilts in various directions by a lateral electric field generated at an end portion of an electrode. In some directions, the liquid crystal does not contribute to a display (liquid crystal molecules parallel to a transmission axis of any of polarizing plates do not cause a phase difference in a crossed Nicol state) so as to cause a problem that a transmittance is lower than the transmittance in a parallel alignment.

JP-A-10-161127 is a first example of related art. In order to prevent the abnormal alignment due to the lateral electric field, a method which makes less leakage of light is disclosed in the first example by making a pretilt angle of a pixel electrode smaller than the pretilt angle of a counter substrate. The pretilt angle of the pixel electrode requires a strong alignment regulating force. However, a substantial average tilt angle which prevents the abnormal alignment due to the lateral electric field is almost same as the tilt angle in a condition of mass production, and the effect of contrast is hardly improved. The alignment layer disposed at a facing surface of both substrates is formed by an oblique evaporation. A plurality of expensive apparatuses such as vacuum deposition system are required when the liquid crystal display device is mass produced. Accordingly, a huge initial investment is required.

JP-A-2002-296597 is a second example of related art. In the second example, a method that prevents alignment defects caused by the lateral electric field when a liquid crystal display method is in a TN-mode is disclosed. In the method, an inorganic alignment layer is formed by the oblique evaporation at an active matrix substrate while an organic alignment layer is formed by a printing method or a coating process which are conventional mass production methods at a counter substrate.

In the second example of related art, the alignment layer at the counter substrate sis formed by the printing method or the coating process which are the conventional mass production methods. Accordingly, the capital investment can be reduced. However, polyimide which is capable of coating and is for the vertical alignment is hard to be tilted from a completely vertical state by a rubbing treatment. For a small or a medium size liquid crystal display device of a viewfinder type, or a large size liquid crystal display device, a direction of a tilt (an incline) when applying the voltage is determined by the lateral electric field generated at the end portion of the electrode and a protrusion included to an electrode surface. In the method, almost invariably, a disclination line caused by conflicts between liquid crystal molecules in a pixel occurs. However, the disclination line is unrecognizable since a size of the pixel is several dozen μm. As for a HTPS(High Temperature Poly Silicone) panel and an LCOS(Liquid Crystal on Silicone) panel which are liquid crystal panels having the size around 10 μm used for a light valve of the projector, the disclination line is visually recognized on projector screen so that a display quality is lowered.

### SUMMARY

An advantage of the invention is to provide a liquid crystal display device having a good contrast characteristic while preventing display failures such as disclination lines and enabling costs to be reduced, a method for manufacturing the liquid crystal display device, and an electronic apparatus using the device.

By forming an inorganic alignment layer having an alignment regulating force such as a pretilt angle and an azimuthal angle at a circuit substrate by an oblique evaporation and applying a vertical alignment layer formed by a coating process at a counter substrate, the inventor has proposed a manufacturing method having an excellent productive efficiency. The method allows reducing the number of vacuum deposition systems and greatly reducing the initial investment. However, the alignment layer having different elements is used for both substrates so that electrical asymmetry (LCcom variation) occurs between the substrates. When the voltage applied to each frame is different, an impurity in the liquid crystal gathers about one of the alignment layers, and a transmittance of each frame varies. It causes flickers. The LCcom variation causes a problem of display failures such as image sticking when the same image is kept displaying for a period of long time. The problem significantly degrades a display quality. Therefore, the invention will be proposed as follows.

According to a first aspect of the invention, a liquid crystal display device, includes: a circuit substrate; a counter substrate oppositely disposed to the circuit substrate; a liquid crystal layer which is sandwiched between the circuit substrate and the counter substrate, and shows a vertical alignment in an initial state; a first alignment layer having an alkyl chain formed by a coating process at a liquid crystal layer of the counter substrate; and a second alignment layer formed by a vacuum deposition process at the liquid crystal layer of the circuit substrate. In the device, an alkyl chain is further bonded on a surface of the second alignment layer.

According to the invention, bonding the alkyl chain on a surface of the second alignment layer enables a difference between the second and the first alignment layers to be reduced. The second alignment layer is formed by the vacuum deposition process at the circuit substrate. The first alignment layer is formed by the coating process at the counter substrate, and has the alkyl chain. Accordingly, a voltage difference of each frame applied between the counter substrate and the circuit substrate can be reduced. As a result, the LCcom variation is stabilized and flickers hardly occur on the displaying image. In addition, display failures such as image sticking hardly occur when the same image display is kept for a long period of time. Thus, the vertical alignment type liquid crystal display having a superior display quality can be obtained.

According to a second aspect of the invention, a method for manufacturing a liquid crystal display device which sandwiches a liquid crystal layer between a circuit substrate and a counter substrate includes: forming a first alignment layer having a linear alkyl chain which is formed by a coating process at a liquid crystal layer of the counter substrate; forming a second alignment layer by a vacuum deposition process at the liquid crystal layer of the circuit substrate; and bonding a linear alkyl chain to a surface of the second alignment layer.

According to the invention, bonding the alkyl chain on the surface of the second alignment layer (an oblique evaporation layer) enables the difference between the second and the first alignment layers to be reduced. The second alignment layer is formed by the vacuum deposition process at the circuit substrate. The first alignment layer is formed by the coating process at the counter substrates, and has the alkyl chain. Therefore the difference in dielectric anisotropy at the counter substrate, the circuit substrate, and each alignment layer is reduced, and a voltage difference in every frame applied between the counter substrate and the circuit substrate can also be reduced. Accordingly, the difference of an effective voltage applied on an electrode under the alignment layer by reversing polarity per a frame is reduced. As a result, the LCcom variation is stabilized, and flickers and image sticking hardly occur when the same display image is kept for a long period of time. Thus, the vertical alignment type liquid crystal display having a superior display quality can be obtained.

In the bonding the alkyl chain to the surface of the second alignment layer, it is preferable that the second alignment layer be surface-treated with a silane coupling agent which includes a linear alkyl group having 6 to 20 carbon atoms. According to the invention, the alkyl chain can be bonded in a state that a shape (a pretilt) of the second alignment layer (oblique evaporation layer) formed by the vacuum process is reflected. The alkyl chain having less than 6 carbon atoms lowers an alignment uniformity of liquid crystal molecules than adopting oblique evaporation. On the other hand, the alkyl chain having more than 20 carbon atoms causes uneven bonding.

According to a third aspect of the invention, an electronic apparatus includes the liquid crystal display device described as above. The invention can provide the electronic apparatus having a high quality display with low costs.

### BRIEF DESCRIPTION OF THE DRAWINGS

The invention will be described with reference to the accompanying drawings, wherein like numbers reference like elements.

FIG. 1 is a sectional view schematically showing an element structure of a liquid crystal display device according to an embodiment of the invention.

FIG. 2 is a sectional view schematically showing a first and a second alignment layers.

FIG. 3 is a partially enlarged view showing an enlarged part (P indicated with a broken line) of FIG. 2.

FIG. 4 is the partially enlarged view showing the enlarged part (Q indicated with a broken line) of FIG. 2.

FIG. 5 is a perspective view schematically showing examples of electronic equipments of the invention.

### DESCRIPTION OF EXEMPLARY EMBODIMENTS

Embodiments of the invention will now be described below with reference to the accompanying drawings. In the accompanying drawings, the layer thickness and the scale of each element is adequately changed so as to provide each member in a recognizable size.

Liquid Crystal Display device

A liquid crystal display device of an embodiment of the invention is a transmissive liquid crystal display device of an active matrix type using thin-film transistors (TFTs) as switching elements.

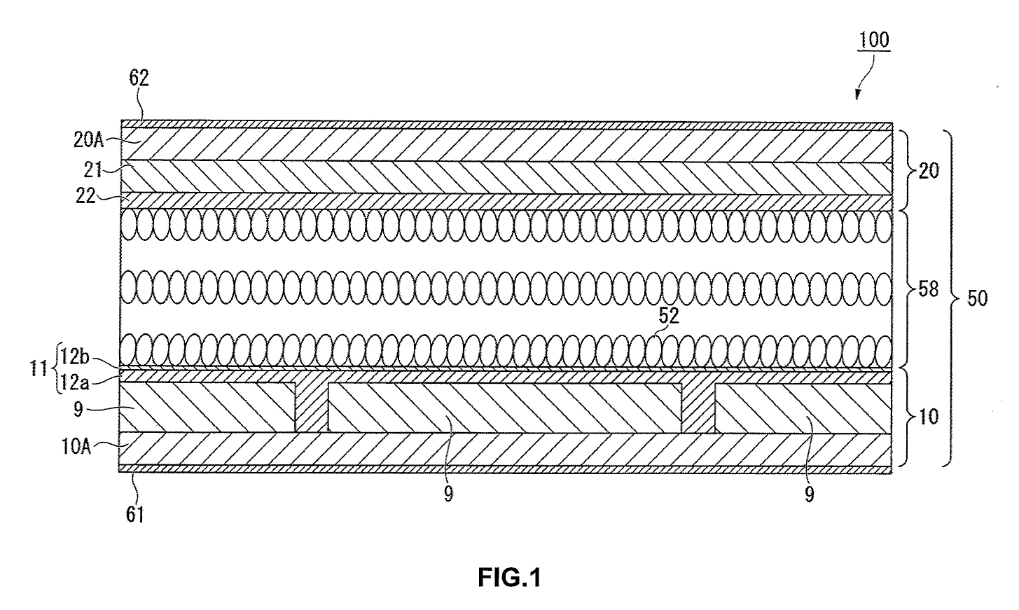

FIG. 1 schematically shows a sectional structure of the liquid crystal display device. The sectional structure (a pixel structure) of the liquid crystal display device of the embodiment is described with reference to FIG. 1. A liquid crystal panel 50 includes a circuit substrate 10, a counter substrate 20 oppositely disposed to the circuit substrate 10, and a liquid crystal layer 58 sandwiched between the circuit substrate 10 and the counter substrate 20. The liquid crystal layer 58 is made of a liquid crystal material that shows a vertical alignment in an initial state, and has negative dielectric anisotropy. The circuit substrate 10 includes a substrate body 10A and a pixel electrode 9 formed on an inner surface of the substrate body 10A. The substrate body 10A is made of a transparent material such as glass. The pixel electrode 9 is made of a transparent conductive material such as indium tin oxide (hereinafter abbreviated as “ITO”) and has a rectangular shape. The circuit substrate 10 also includes TFT elements serving as switching elements for controlling energization of the pixel electrodes 9, date lines through which image signals are supplied, scan lines, and the like (all not shown), and may include a function of a light-shielding layer.

The counter substrate 20 includes a substrate body 20A and a common electrode 21. The substrate body 20A is made of the transparent material such as glass. The common electrode 21 is formed on the inner surface of the substrate body 20A, and is made of a transparent conductive layer such as ITO. The common electrode 21 is not divided corresponding to each pixel region, and flatly and entirely formed on the substrate body 20A. The counter substrate 20 also may include color filters and light-shielding layers.

The counter substrate 20 also includes a first alignment layer 22 having vertical alignment property so as to cover the common electrode 21 while the circuit substrate 10 includes a second alignment layer 11 having a pretilt so as to cover a plurality of the pixel electrodes 9. In the liquid crystal layer 58 sandwiched between the counter substrate 20 and the circuit substrate 10, liquid crystal molecules 52 are vertically aligned in an initial state (in which no voltage is applied) therebetween.

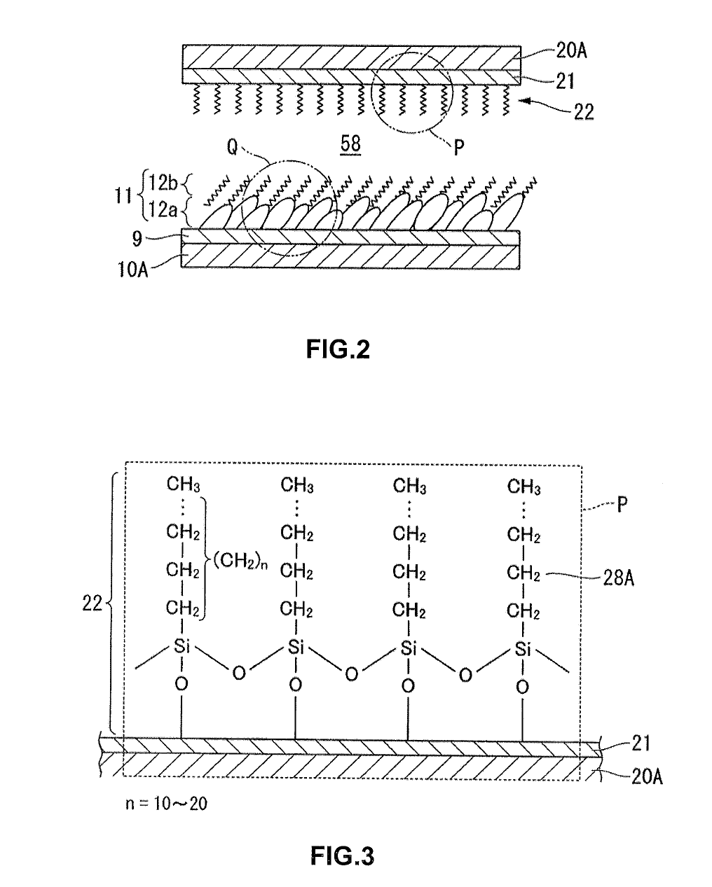

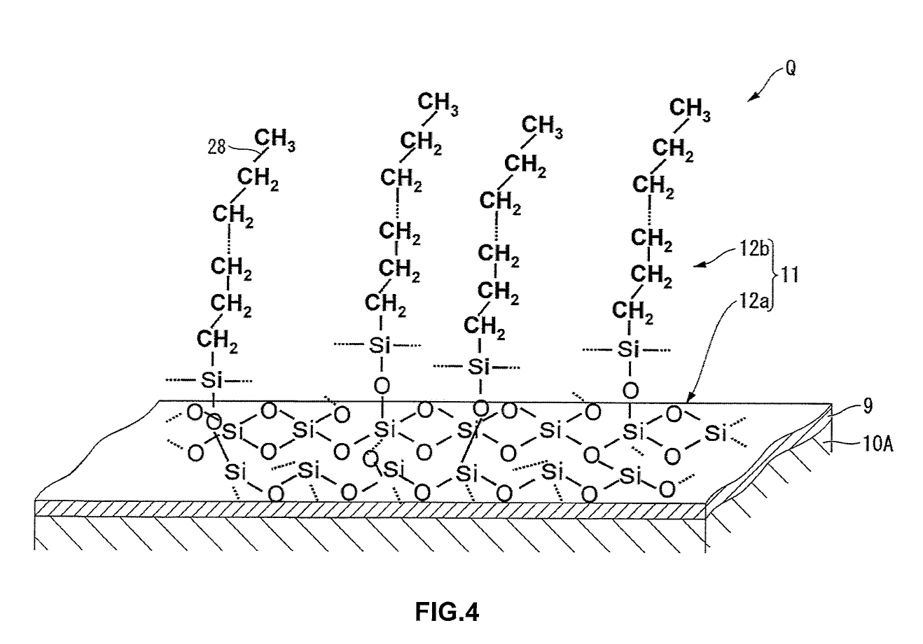

Here, the second alignment layer 11 of the circuit substrate 10 is distinctive elements of the invention. That is, in the invention, the second alignment layer 11 is composed of an inorganic layer 12a and a surface layer 12b which is composed of any functional group. The specific structures of the first alignment layer 22 and the second alignment layer 11 are described with reference to FIG. 2 in which the structures of the first alignment layer 22 and the second alignment layer 11 are schematically shown. FIG. 3 is a partially enlarged view showing an enlarged part (P indicated with a broken line) in FIG. 2. FIG. 4 is the partially enlarged view showing the enlarged part (Q indicated with the broke line) in FIG. 2.

First Alignment Layer

As shown in FIGS. 2 and 3, the first alignment layer 22 shows nearly the vertical alignment without any specific azimuthal angle, and modifies a surface of the common electrode 21 with a linear alkyl chain 28A. The first alignment layer 22 can be obtained by coating the substrate body 20A with an alignment layer material using a coating process such as a spin coating and a flexographic printing.

Examples of the alignment layer forming material include a vertical alignment type of polyimide which is commonly used as a vertical alignment agent, a compound that can self-assemble such as a silicon based compound and an organic silane. The silicon based compound and the organic silane include a region that can be chemically adsorbed (bonded) to the substrate (e.g., an alkoxy group forms a silanol group by hydrolysis) and a part having a vertical alignment towards the liquid crystal molecules (e.g., an alkyl group having 10 to 20 carbon atoms).

Second Alignment Layer

As shown in FIG. 2, the second alignment layer 11 includes the inorganic layer 12a and the surface layer 12b. The inorganic layer 12a is obtained by depositing the alignment layer material on the substrate body 10A by an oblique evaporation. Examples of the material for the second alignment layer 11 include a silicic compound of SiO₂ or SiO and a metal oxide such as Al₂O₃, ZnO, MgF, or ITO.

As shown in FIG. 4, the surface layer 12b is formed on the inorganic layer 12a, and is composed mainly of an alkyl chain 28B having 6 to 20 carbon atoms bonded to a Si atom of the inorganic layer 12.

As shown in FIGS. 2 and 4, the alkyl chain 28B roughly reflects a surface shape of the oblique evaporation (the inorganic layer 12a). That is, since the alkyl chain 28B is nearly extended (bonded) along a shape of the inorganic layer 12a (an oblique evaporation layer), the alkyl chain 28B has the pretilt similarly to that of the oblique evaporation. Although the alkyl chain 28B may have a slight variation of the pretilt angle, the original state of the oblique evaporation is kept in the azimuthal angle.

The alkyl chain having less than 6 carbon atoms causes lowering of an alignment uniformity of the liquid crystal, thereby the alkyl chain may not function as the alignment layer. When the alkyl chain having more than 20 carbon atoms is used, steric hindrance between the adjacent alkyl chains become too large so that the alkyl chain 28B is bonded unevenly on the inorganic layer 12a. The alkyl chain having 6 to 20 carbon atoms reflects a large part of the pretilt of the inorganic layer 12a due to the influence of steric hindrance of the alkyl chains 28B adjacent to each other on the inorganic layer 12a.

The inorganic layer 12a is surface-treated with a silane coupling agent which includes the alkyl group having a predetermined number of carbon atoms so as to form the surface layer 12b on the inorganic layer 12a, thereby the inorganic layer 12a and the surface layer 12b serve as the second alignment layer 11. The surface layer 12b is composed of the alkyl chain 28 (organic substances). Consequently, the second alignment layer 11 has the same organic group as a structure of the first alignment layer 22 so as to reduce asymmetry of an alignment layer component.

The liquid crystal layer 58 is sandwiched between the circuit substrate 10 and the counter substrate 20. The liquid crystal layer 58 shows the vertical alignment in the initial state by the first alignment layer 22 and the second alignment layer 11. In addition, a pair of polarizing plates 61 and 62 disposed on both sides of the liquid crystal panel 50 in such a manner that a polarization axis of the polarizing plate 61 makes an angle of about 45 degrees with respect to an azimuthal angle of the liquid crystal while the polarization axis of the polarizing plate 62 makes the angle of about 135 degrees with respect to azimuthal angle of the liquid crystal. The polarization axes of the polarizing plates 61 and 62 are almost orthogonal to each other. Further, a light source unit (not shown) is disposed below the polarizing plate 61. The liquid crystal display device 100 of the embodiment is thus structured.

In the liquid crystal display device 100 structured as above, when no voltage is applied, the liquid crystal molecules 52 at an interface are vertically aligned, and make an angle about 90 degrees with respect to a substrate surface by the first alignment layer 22 at a counter substrate 20 side. The liquid crystal molecules 52 at the interface are vertically aligned and make a predetermined pretilt angle with respect to the substrate surface by the second alignment layer 11 at a circuit substrate 10 side. Thus, the liquid crystal molecules 52 sandwiched by the counter substrate 20 and the circuit substrate 10 are vertically aligned with respect to the substrate surface.

The voltage is applied between the pixel electrode 9 and the common electrode 21 so that the liquid crystal molecules 52 of the liquid crystal layer 58 can be tilted almost parallel to the substrate surface.

In the embodiment, the alkyl group which the first alignment layer 22 includes is also formed on the inorganic alignment layer of the second alignment layer 11. Accordingly, when the voltage is applied between the common electrode 21 and the pixel electrode 9, a dielectric constant between both substrates 10 and 20 can be balanced. That is, if the structure of each of the alignment layers 22 and 11 in the liquid crystal panel 50 is different, impurity ions and the like in the liquid crystal layer 58 are eccentrically gathered at one side of the alignment layer. Therefore, the voltage applied between the pixel electrode 9 and the common electrode 21 is asymmetric so that display failures such as flickers and image sticking can easily occur. However, the structure of each of the alignment layers 22 and 11 is the same, so that electrical asymmetry between the both substrates 10 and 20 hardly occurs. Therefore, it is possible to stabilize LCcom variation in a long term drive so as to improve a display quality.

Manufacturing Method

A method for manufacturing the liquid crystal display device according to the embodiment of the invention will be described.

First, the substrate body 20A having a transparency and made of glass or the like is prepared. Then, a light-shielding layer (not shown) and the common electrode 21 are formed by a known method. Then, the first alignment layer 22 is formed on the common electrode 21. The first alignment layer 22 is formed by coating the counter substrate 20 with the alignment layer material having a long-chain alkyl group by the spin coating and the flexographic printing. Then a chemical reaction of the common electrode 21 made of ITO with the alkyl group enables a self-assembled monolayer (SAM) to be formed on the substrate body 20A. The SAM covers the common electrode 21.

Specifically, the substrate body 20A is coated with an octadecyltrimethoxysilane (ODS) methanol solution in an N₂ atmosphere so as to form the SAM having the alkyl group (an octadecyl group) on the common electrode 21 as shown in FIG. 3. The first alignment layer 22 is thus formed on the substrate body 20A. The first alignment layer 22 has an organic/inorganic hybrid structure which having Si as a main chain backbone. In addition, the self-assembled monolayer (the first alignment layer 22) can be formed by other known method.

The coating process is not particularly limited. Various methods can be employed in addition to the method described above. A dipping method (dip coating method), the spray coating method, various printing methods, and an inkjet method are preferably used.

Then, the substrate body 10A having the transparency and made of glass or the like is prepared. Then, the light-shielding layer, a semiconductor layer, various wiring lines such as the scan lines and the data lines (all not shown), and the pixel electrode 9 are formed by the known method. As shown in FIGS. 1 and 2, the oblique evaporation layer is formed on the pixel electrode 9 with a vacuum deposition system so as to obtain the inorganic layer 12a which composes the second alignment layer 11. In the vacuum deposition system, the substrate body 10A is set so that an angle between a face on which the layer is formed and an incident direction of the layer material with respect to the face on which the layer is formed is less than 90 degrees. As a result, an orthorhombic crystal is grown on the face on which the layer is formed so as to form the layer having a desired oblique evaporation columnar structure (the pretilt). After the inorganic layer 12a is thus formed on the substrate body 10A, the inorganic layer 12a is surface-treated.

As for the surface treatment, the substrate body 10A having the inorganic layer 12a is dipped into the silane coupling agent solution having the long-chain alkyl group for a predetermined time. Here, the silane coupling agent includes an organic functional group and a hydrolysis group in a single molecule, by which in organic substances and organic substances are combined, enabling the physical strength, durability, and adhesiveness of a material to improve. Specifically, it is represented by the following chemical formula. An organic functional group and 2 to 3 organic groups reacting with an inorganic substance are bonded to a silicon atom (Si).

Chemical Formula

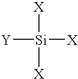

X: hydrolysis group bonded to silicon atom

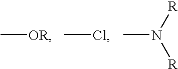

and the like (R is alkyl group)
Y: organic functional group which reacts with organic matrix, —R and the like

The silane coupling agent to be used is not particularly limited as long as the organic functional group has good repellency and a light durability. Specifically, one having an alkyl group as an organic functional group (Y) in the chemical formula is preferably used. The hydrolysis group is also not particularly limited. A group having a small molecular weight such a methoxy group (—O—CH₃) or an ethoxy group (—O—C₂H₅) is preferably used since they are not easy to cause steric hindrance when they are reacted with and added to the surface of the inorganic layer 12a.

When the silane coupling agent is brought into contact with the surface of the inorganic layer 12a, as shown in FIGS. 2 and 4, the alkyl chain 28B is bonded along an oblique evaporation columnar structure of the inorganic layer 12a. At this time, since a long-chain of the alkyl group is extended in a direction of an orthorhombic crystal growth, the alkyl chain 28B also has the similar pretilt (the alignment regulating force on the liquid crystal molecules 52) as the inorganic layer 12b has.

Thus, the surface of the inorganic layer 12a is modified with the alkyl chain 28B so as to obtain the surface layer 12b made of the organic substances on the inorganic layer 12a. Accordingly, the second alignment layer 11 can be obtained. The second alignment layer 11 has the same structure as the first alignment layer 22 which can be formed by the coating process of the counter substrate 20, i.e., the organic/inorganic hybrid alignment layer. Therefore, electrical asymmetry between the both substrates 10 and 20 hardly occurs, thereby a uniform display without abnormal displays can be achieved.

As for the surface treatment with the silane coupling agent, a chemical vapor deposition method also can be employed as well as a liquid coating method described above. In the chemical vapor deposition method, the substrate body 10 having the inorganic layer 12a may be put into a chamber capable of being tightly closed, and then the silane coupling agent may be introduced into the chamber as steam for the surface treatment.

Specifically, as an example, the substrate body 10 having the inorganic layer 12a is dried at about 150 to about 180 degrees centigrade for about 3 hours in the N₂ atmosphere. Then the substrate body 10A is left inside the tightly closed chamber together with a container holds, for example, the ODS solution therein. The container is heated, for example, at 150 degrees centigrade for about 1 hour, whereby vapor of the ODS solution comes into contact with the surfaces of the inorganic layer 12a of the substrate body 10A. As a result, the long-alkyl group of the ODS molecule is bonded on the inorganic layer 12a since the long-alkyl group includes an inorganic reactive group. The surface layer 12b is thus formed on the inorganic layer 12a so as to obtain the second alignment layer 11.

In the vertical alignment type liquid crystal display device 100 of the embodiment, the self-assembled monolayer is formed by the coating process at the counter substrate 20 so as to obtain the first alignment layer 22 (a vertical alignment layer) which has the organic/inorganic hybrid structure. On the other hand, the inorganic layer 12a having the pretilt is formed by the oblique evaporation method at the circuit substrate 10. Then, the surface layer 12b is formed on the inorganic layer 12a by the surface treatment with the silane coupling agent. As a result, the second alignment layer 11 has the same organic/inorganic hybrid structure as the first alignment layer 22 described above. As described, the alignment layers 11 and 22 have the same elements so that the voltage applied to the circuit substrate 10 and the counter substrate 20 is almost equal. It allows stabilizing the LCcom variation so as to obtain the liquid crystal display device 100 having a superior display quality without display failures such as the image sticking when the same image display is kept for a long period of time.

In addition, one of the substrates that compose the liquid crystal panel 58, the first alignment layer 22 of the counter substrate 20 here, is formed by the coating process so as to reduce the number of the vacuum deposition system used for manufacturing the liquid crystal display device 100. Since the number of the vacuum layer forming apparatuses used is reduced, massive investment becomes unnecessary, and the first alignment layer 22 can be formed with a high productivity by conventional alignment layer coating apparatuses. Consequently, a vertically aligned light valve having a superior display quality can be provided with low costs.

### EXAMPLE 1

At the circuit substrate 10, the second alignment layer 11 was formed by the oblique evaporation method so as to give the alignment regulating force on the pretilt angle and the azimuthal angle of the liquid crystal molecules 52. Further, 1 wt % of a solution of an octadecyltrimethoxysilane/methanol was adjusted. The circuit substrate 10 was dipped into the solution at room temperature for 30 minutes, and then taken out. The substrate was cleaned with dekalin, and then heated at 120 degrees centigrade for 1 hour in a heated oven.

At the counter substrate 20, the substrate body 20A was coated with the solution of organic/inorganic hybrid material which having Si as the main chain backbone.

The circuit substrate 10 and the counter substrate 20 completed as described above were bonded. A liquid crystal material which has negative dielectric anisotropy was injected through an injection hole, and then the injection hole was sealed to complete the liquid crystal panel 50. Then, the polarizing plates 61 and 62 were bonded in such a manner that their transmission axes respectively make angles of about 45 degrees and about 135 degrees with respect to the alignment direction of the liquid crystal panel 50 (the azimuthal angle of the liquid crystal molecules 52 is 0 degree), whereby the liquid crystal display device 100 was completed.

An electric signal was inputted to the liquid crystal display device 100, and the voltage on the pixel electrode 9 was turned on and off. When the voltage was turned on, a bright uniform white display was obtained in each pixel. When the voltage was turned off, a black display with less leakage of light due to the vertical alignment could be obtained. A black window was kept displaying in a whole white display screen for about 10 hours, then the screen was turned to the whole white display again. The uniform white display without any display hysteresis of the black window could be provided.

Electronic Apparatus

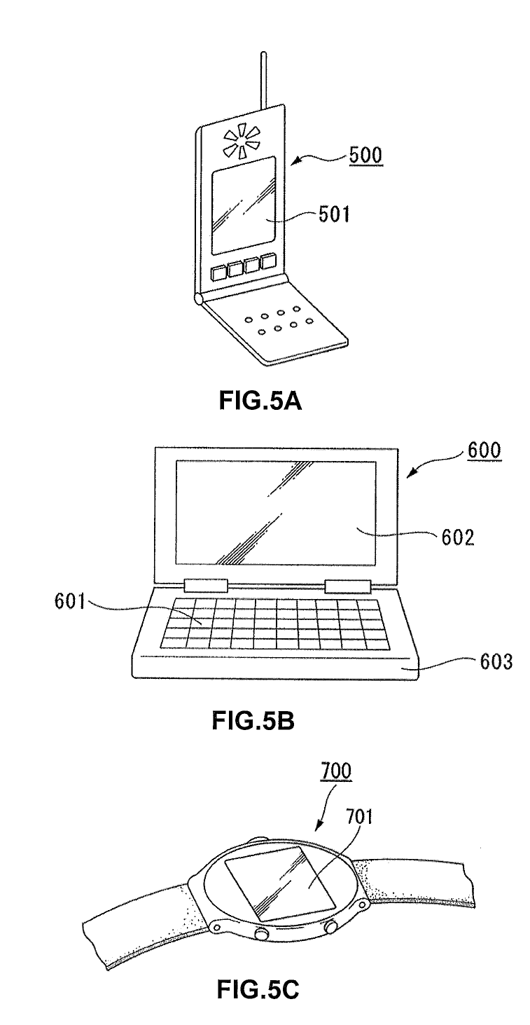

Examples of electronic apparatus equipped with the liquid crystal display device of the embodiment will be described. FIG. 5A is a perspective view showing an example of cellular phones. In FIG. 5A, a cellular phone 500 has a liquid crystal display 501 using the liquid crystal display device of the embodiment.

FIG. 5B is a perspective view showing an example of portable information processing units such as a word processor and a personal computer. In FIG. 5B, an information processing unit 600 includes: an input section 601 such as a keyboard; an information processing unit 603; and a liquid crystal display 602 using the liquid crystal display device of the embodiment.

FIG. 5C is a perspective view showing an example of wristwatch type electronic apparatuses. In FIG. 5C, a watch 700 includes a liquid crystal display 701 using the liquid crystal display device of the embodiment.

The electronic apparatuses shown in FIGS. 5A to 5C employ the liquid crystal display device, which is an example of the invention as displays. Therefore, the electronic apparatuses can maintain a high contrast and a high quality display for a long period of time without problems of displaying rubbing stripes caused by a rubbing process, for example.

The preferred embodiment of the invention has been described with reference to the accompanying drawings as above. The invention is not limited to the embodiment, and the examples and the embodiment may be combined. Naturally, those skilled in the art will be able to presume many variations and modifications within the purview of the technical idea disclosed in the scope of claims of the invention. It will be understood that those variations and modifications are obviously within the technical scope of the invention.

In the above embodiment, a coating type vertical alignment layer is formed with the SAM. However, it is not particularly limited to this.

What is claimed is:

1. A liquid crystal display device, comprising:
a circuit substrate;
a counter substrate oppositely disposed to the circuit substrate;
a liquid crystal layer which is sandwiched between the circuit substrate and the counter substrate, and shows a vertical alignment in an initial alignment state;
a first alignment layer having an alkyl chain formed by a coating process at a liquid crystal layer of the counter substrate; and
a second alignment layer formed by a vacuum process at the liquid crystal layer of the circuit substrate, wherein an alkyl chain is further bonded on a surface of the second alignment layer.

2. A method for manufacturing a liquid crystal display device which sandwiches a liquid crystal layer between a circuit substrate and a counter substrate, the method comprising:
forming a first alignment layer having a linear alkyl chain which is formed by a coating process at a liquid crystal layer of the counter substrate;
forming a second alignment layer by a vacuum process at the liquid crystal layer of the circuit substrate; and
bonding a linear alkyl chain to a surface of the second alignment layer.

3. The method for manufacturing a liquid crystal display device according to claim 2, wherein in bonding the alkyl chain to the surface of the second alignment layer, the second alignment layer is surface-treated with a silane coupling agent which includes a linear alkyl group having 6 to 20 carbon atoms.

4. An electronic apparatus comprising:
the liquid crystal display device according to claim 1.
